(19) United States
(12) Patent Application Publication
(10) Pub. No.: US 2009/0317774 A1
(43) Pub. Date: Dec. 24, 2009

(54) METHOD AND APPARATUS FOR CREATING PERSONALIZED ART

(76) Inventor: Laurie Sharp, Clearwater, FL (US)

Correspondence Address: LARSON AND LARSON, 11199 69TH STREET NORTH, LARGO, FL, 33773, US

(21) Appl. No.: 12/143,152

(22) Filed: Jun. 20, 2008

(51) Int. Cl. B05D 5/00

(52) U.S. Cl. 434/84; 427/256

(57) ABSTRACT

An application for a method and apparatus for creating a work of art includes providing an artistic kit that has a source of a pigment and an applicator. The applicator accepts the pigment and is used to apply the pigment to a unique part of a user's anatomy. The kit includes at least one artistic medium having a pre-printed design on a front side and a location adapted to accept an impression of the unique part of a user's anatomy. The applicator is used to coat the unique part of a user's anatomy with the pigment, then the unique part of a user's anatomy with the pigment is pressed onto the location adapted to accept an impression within the pre-printed design, thereby creating a work of art unique to the user.

### FIELD OF THE INVENTION

This invention relates to the field of creating unique works of art and more particularly to a method and apparatus for creating art that includes a unique aspect of a person's body.

### BACKGROUND OF THE INVENTION

There are many ways to create art. In early days, cave men and woman carved pictures on walls of their caves. Later, this progressed to sculpting figures in stone or wood, painting with various paints and media, photography, etc. Great artists such as Picasso, Michelangelo and Van Gogh have used their immense artistic skills to create such works as the Mona Lisa and Starry Nights. Several shortcuts have been created for those of us who would like to be artistic, but lack the creativity, ability and discipline of such great artists. Various artistic creation tools and kits are available to make artists out of those who are not quite artistic in nature. Such tools include stamp kits (instead of drawing a tree, a tree stamp is provided), paint-by-number kits and color-by-number kits (colored pencils). The result, the less-than-artistic person is now able to create a “work-of-art.” Unfortunately, such art is not unique and it would be hard to distinguish an oil of Mount Rushmore painted by one person from another oil of Mount Rushmore painted by another using the same kit.

Similarly, art has been applied to the human body in several forms. Makeup is one form, adding color and cover-up to a person's face and nails. As an example, U.S. Pat. No. 6,035,857 describes a kit for decorating a person's nails. The kit includes a base with compartments for nail polish, fancy patterns, etc. The kit also includes a mirror and a fan for drying the nail polish. The described invention works well for creating individual art on one's fingers, but such art is not easily provided to another or given as a gift.

Another well known form of body art is tattoos. In such, a tattoo artist applies permanent ink of various colors beneath the outer layer of a person's skin in an artistic pattern. Such patterns often represent words, animate objects (e.g., an eagle), scenes, Kanji characters and the like. Since the artist creates each tattoo free-hand, each tattoo is somewhat unique and dependent upon the skill of the artisan.

None of the present art creation methods, tools and devices provides artistic, unique and personal works of art that are easy to create by the average person.

What is needed is a method and apparatus that provides for the creation of unique and personal art that can be given to another person as a lasting gift.

### SUMMARY OF THE INVENTION

In one embodiment, an artistic kit is disclosed including a source of a pigment and an applicator. The applicator is adapted to accept the pigment from the source of the pigment and to apply the pigment to a unique part of a user's anatomy such as a nipple. The kit also includes an artistic medium with a pre-printed design on a front side and a location for accepting an impression of the unique part of a user's anatomy. The artistic kit is used to create works of art that are unique to an individual user.

In another embodiment, a method of creating a work of art is disclosed including providing an artistic kit that has a source of a pigment and an applicator. The applicator accepts the pigment and is used to apply the pigment to a unique part of a user's anatomy. The kit includes at least one artistic medium having a pre-printed design on a front side and a location adapted to accept an impression of the unique part of a user's anatomy. The applicator is used to coat the unique part of a user's anatomy with the pigment, then the unique part of a user's anatomy with the pigment is pressed onto the location adapted to accept an impression within the pre-printed design, thereby creating a work of art unique to the user.

In another embodiment, an artistic kit is disclosed including an applicator having a pigment. The applicator is for applying the pigment to a nipple of a user. The kit includes an artistic medium with a design pre-printed on a front side and with a location in the design adapted to accept an impression of the nipple.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates an isometric view of an artistic development kit of a first embodiment of the present invention.

FIG. 1A illustrates an isometric view of an artistic development kit of a second embodiment of the present invention.

FIG. 2 illustrates an isometric view of the first embodiment of the present invention in use.

FIG. 2A illustrates an isometric view of the second embodiment of the present invention in use.

FIG. 3 illustrates an isometric view of all embodiments of the present invention in use.

FIG. 4A illustrates a plan view of art created with the use of the present invention.

FIG. 4B illustrates a plan view of art created with the use of the present invention.

FIG. 5 illustrates a plan view of art created with the use of the present invention in a frame.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures. Throughout the following description, the term “unique part of a user's anatomy” refers to a portion of a user's body that is generally unique with respect to other people. For example, a nipple, ear lobe, belly button or the tip of a penis are generally unique to an individual.

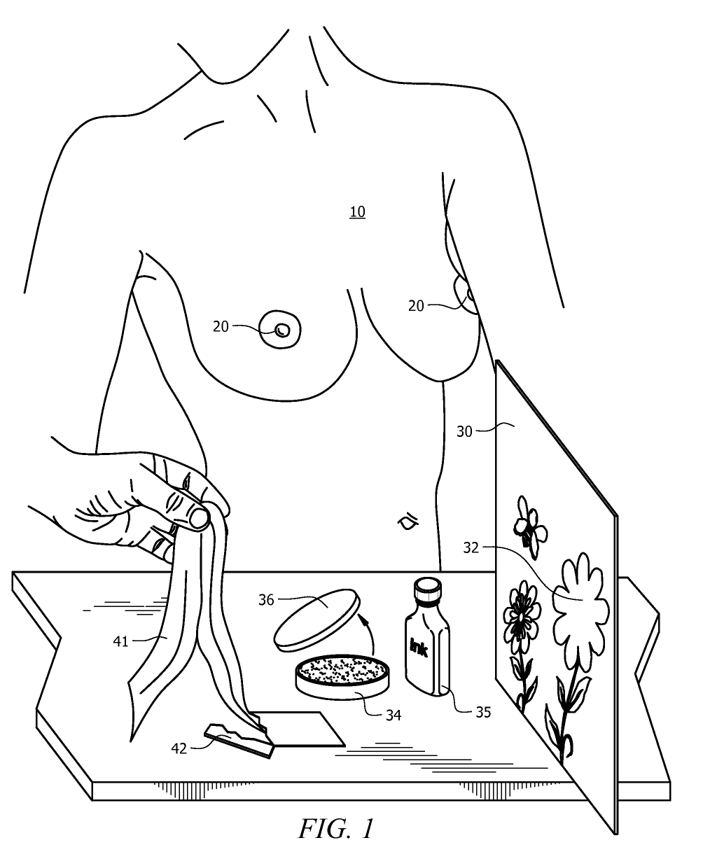

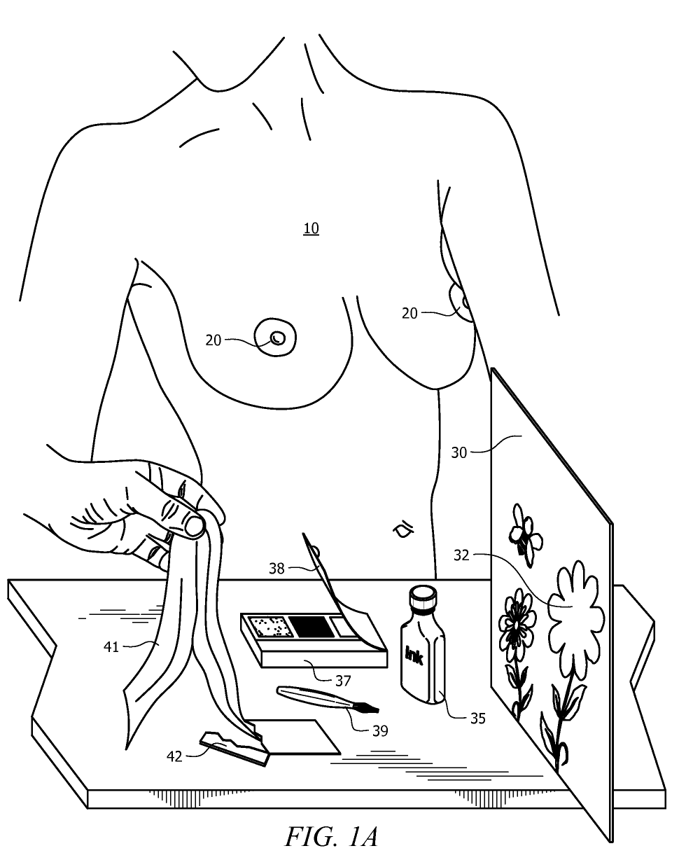

Referring to FIG. 1, an isometric view of an artistic development kit of a first embodiment of the present invention is shown. In this embodiment, the kit consists of a coloring or inking device 34 and a pre-printed artistic medium 30 with a location 32 for placing a unique artistic impression. In the example shown, the artistic medium is a flat sheet, preferably made from high-grade, stiff paper or coated cardboard. In alternate embodiments, the artistic medium is a three-dimensional object such as a figurine, statue, coaster, ash tray, coffee mug, etc. The artistic medium 30 includes pre-printed images that accentuate the unique artistic impression; in this example flowers of which one flower has the location 32 for placing the unique artistic impression. In some embodiments, the artistic medium 30 is also pre-printed with a company logo such as a famous restaurant, etc. In embodiments in which the artistic medium 30 is three dimensional, it is preferred that the location 32 for placing the unique artistic impression be substantially flat or slightly curved in order to accept a quality impression. In some embodiments, a coating is provided (not shown) to help preserve the impression so as not to wear off with use as would occur with a three-dimensional object that is used such as a coffee cup.

In some embodiments of the present invention, the inking device 34 is a sponge or stamp pad pre-loaded with a source of pigment such as ink or paint. In this embodiment of the present invention, the inking device has a cover 36 for maintaining the pigment (e.g., ink or paint) until it is used. In some embodiments of the present invention, the kit includes a pre-moistened towel 41 that is provided in a packet 42, typically a foil packet for preserving the moistening agent until needed. Preferably, the moistening agent is formulated to remove the pigment (ink or paint) from a person's body 10 after application. As shown, the person 10 is ready to apply the pigment (e.g., ink or paint) to a unique location of their body, in this case one or both nipples 20, although it is anticipated that the same artistic kit will also work with other unique portions of the body such as an ear lobe or the tip of a penis.

Referring to FIG. 1A, an isometric view of an artistic development kit of a second embodiment of the present invention is shown. In this embodiment, the kit consists of an inking device 39 and a pre-printed artistic medium 30 with a location 32 for placing a unique artistic impression. The artistic medium 30 includes pre-printed images that accentuate the unique artistic impression; in this example flowers of which one flower has the location 32 for placing the unique artistic impression. In this embodiment of the present invention, the inking device 39 is a brush 39 or cotton swab (not shown). In some embodiments, the source of ink or paint is a tray or container 37 having wells with one or more colors of ink or paint. In some embodiments, the source of ink or paint has a peel-off or snap-off cover 38 for preventing the ink or paint from drying out until it is used. In an alternate embodiment, the ink or paint is supplied in an ink or paint bottle 35. In some embodiments, the pigment (e.g., ink or paint) is applied with an airbrush or felt-tip marker.

In some embodiments of the present invention, the kit includes a pre-moistened towel 41 that is provided in a packet 42, typically a foil packet for preserving the moistening agent until needed. Preferably, the moistening agent is formulated to remove the ink or paint from a person's body 10 after application. As shown, the person 10 is ready to apply the ink or paint to a unique location of their body, in this case one or both nipples 20, although it is anticipated that the same artistic kit will also work with other unique portions of the body such as an ear lobe or the tip of a penis. It is also anticipated that, in some embodiments of the method, will blot excessive ink from the unique location of their body before transferring the ink from the unique location of their body onto the artistic medium 30.

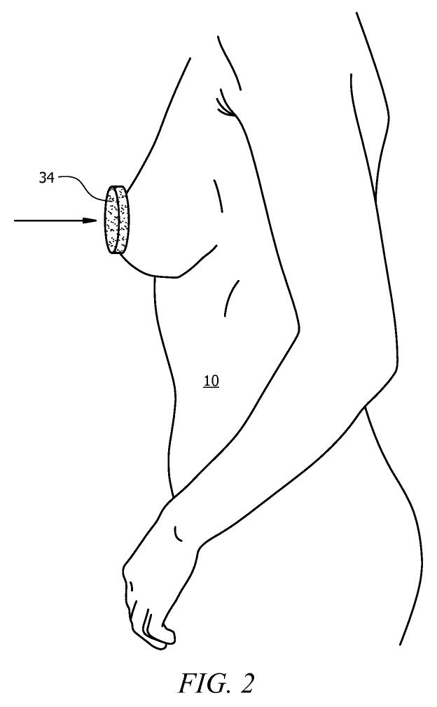

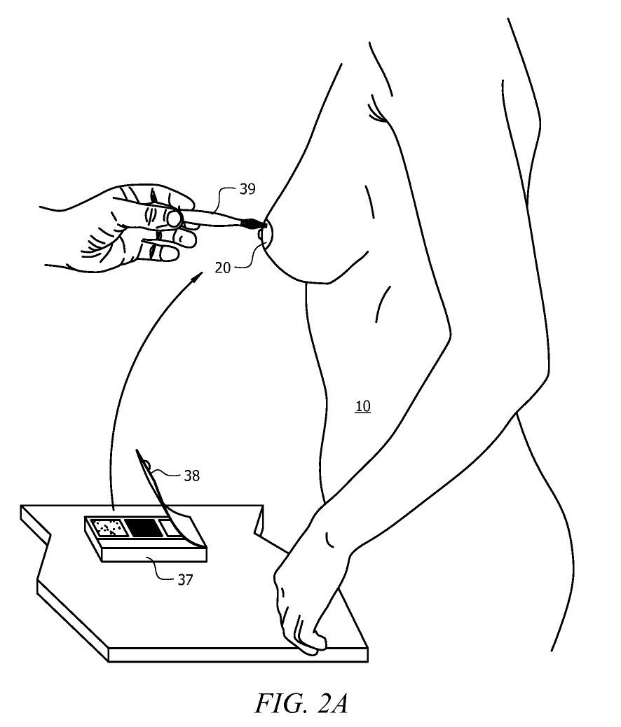

Referring to FIG. 2, an isometric view of the first embodiment of the present invention in use is shown. In this example, the ink or paint is applied using the stamp pad or sponge 34 to the desired unique part of the user's 10 anatomy, in this example, the nipple 20 (not visible). The same process works on other parts of the user's anatomy such as an earlobe or penis. The ink or paint is applied to a desired circumference. It is preferred, but not required, that the circumference be similar to the circumference of the location 32 for placing the unique artistic impression so as to not invade the pre-printed area of the artistic medium 30. The entire process is performed by the user 10 or with the help of another person.

Referring to FIG. 2A, an isometric view of the second embodiment of the present invention in use is shown. In this, the ink or paint is applied by dipping the brush 39 into the source of ink or paint 37 (or bottle 35), then coloring the unique part of the user's 10 anatomy, in this example, their nipple 20 (not visible). The ink or paint is applied to a desired circumference. It is preferred, but not required, that the circumference be similar to the circumference of the location 32 for placing the unique artistic impression so as to not invade the pre-printed area of the artistic medium 30. In some embodiments, a template is provided (not shown) to guide the user in inking/painting an area equivalent to the location 32 for placing the unique impression.

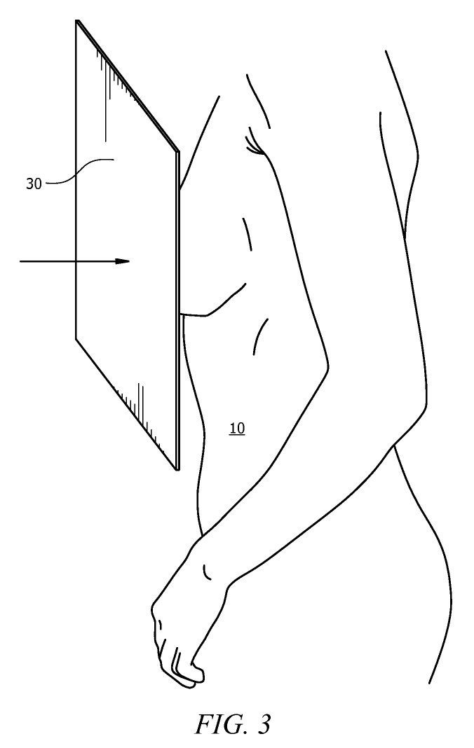

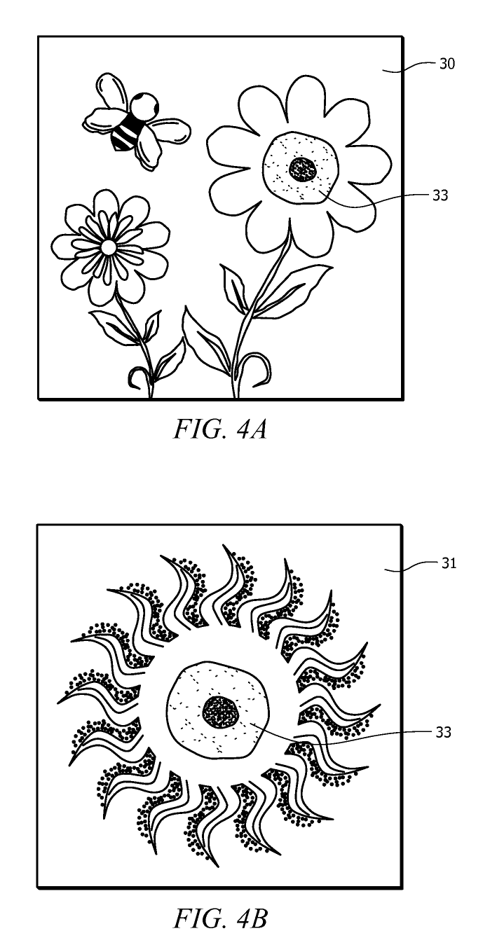

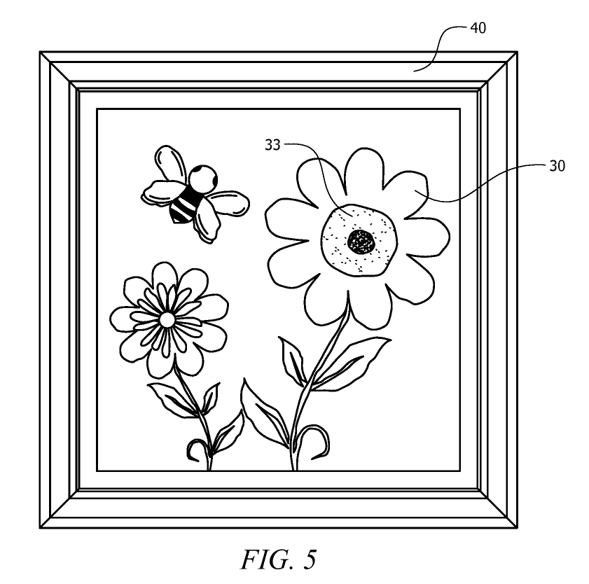

Referring to FIG. 3, an isometric view of all embodiments of the present invention in use is shown. Once the ink or paint is applied to the unique part of the user's 10 anatomy (e.g., nipple 20), an impression of the unique part of the user's 10 anatomy is transferred to the location 32 for placing the unique artistic impression. The location 32 for placing the unique artistic impression on the artistic medium 30 is aligned with the unique part of the user's 10 anatomy (e.g., nipple 20) and the artistic medium 30 is pressed against the unique part of the user's 10 anatomy (e.g., nipple 20) to transfer an image of the unique part of the user's 10 anatomy (e.g., nipple 20) to the location 32 for placing the unique artistic impression. This results in an impression of the unique part of the user's 10 anatomy (e.g., nipple 20) appearing within a design of the artistic medium 30 as will be shown in FIGS. 4A, 4B and 5. In some embodiments, the pre-moistened towel 41 is used to remove excessive ink/paint from the unique part of the user's 10 anatomy (e.g., nipple 20) to improve the contrast of the resulting impression.

Referring to FIG. 4A, a plan view of art created with the use of the present invention is shown. In this example, the artistic medium 30 includes pre-printed images of flowers and a bee. The unique part of the user's 10 anatomy is a nipple 20 and the impression of the nipple 33 appears as part of a flower, thereby slightly disguising the origin of that part of the resulting artistic work. Such disguising allows a friend or lover to display the artistic work in public or private with increased discretion.

Referring to FIG. 4B, a plan view of art created with the use of the present invention is shown. In this example, the artistic medium 30 includes an artistic pre-printed image of the sun. The unique part of the user's 10 anatomy is a nipple 20 and the impression of the nipple 33 appears as part of a sun, thereby slightly disguising the origin of that part of the resulting artistic work. Such disguising allows a friend or lover to display the artistic work in public or private with increased discretion.

Referring to FIG. 5, a plan view of art created with the use of the present invention in a frame is shown. As in FIG. 4A, the artistic medium 30 in this example includes pre-printed images of flowers and a bee. The unique part of the user's 10 anatomy is a nipple 20 and the impression of the nipple 33 appears as part of a flower, thereby slightly disguising the origin of that part of the resulting artistic work. The final artistic work is placed in a frame 40. In some embodiments, the frame 40 is provided as part of the kit.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A artistic kit comprising:
a source of a pigment;
an applicator, the applicator adapted to accept the pigment from the source of the pigment and adapted to apply the pigment to a unique part of a user's anatomy;
an artistic medium;
a pre-printed design on a front side of the artistic medium; and
a location adapted to accept an impression of the unique part of a user's anatomy within the pre-printed design.

2. The artistic kit of claim 1, wherein the pigment is selected from the group consisting of paint and ink and the source of pigment is a tray having a peel-off cover.

3. The artistic kit of claim 1, wherein the pigment is selected from the group consisting of paint and ink and the source of pigment is a bottle.

4. The artistic kit of claim 1, wherein the applicator is a sponge.

5. The artistic kit of claim 1, wherein the applicator is a stamp pad.

6. The artistic kit of claim 1, wherein the applicator is a brush.

7. The artistic kit of claim 1, wherein the unique part of the user's anatomy is a nipple.

8. The artistic kit of claim 1, wherein the preprinted design includes images of flowers.

9. A method of creating a work of art, the method comprising:
providing an artistic kit, the artistic kit comprising:
a source of a pigment;
an applicator, the applicator adapted to accept the pigment from the source of the pigment and adapted to apply the pigment to a unique part of a user's anatomy;
an artistic medium;
a pre-printed design on a front side of the artistic medium;
a location adapted to accept an impression of the unique part of a user's anatomy within the pre-printed design;
using the applicator to coat the unique part of a user's anatomy with the pigment;
pressing the unique part of a user's anatomy with the pigment onto the location adapted to accept an impression of the unique part of a user's anatomy within the pre-printed design.

10. The method of claim 9, wherein the pigment is selected from the group consisting of paint and ink and the source of pigment is a tray having a cover.

11. The method of claim 10, wherein the cover is a peel-off cover.

12. The method of claim 10, wherein the cover is a snap-off cover.

13. The method of claim 9, wherein the applicator is a sponge.

14. The method of claim 9, wherein the applicator is a stamp pad.

15. The method of claim 9, wherein the applicator is a brush.

16. The method of claim 9, wherein the unique part of the user's anatomy is a nipple.

17. The method of claim 9, wherein the artistic kit further comprises a pre-moistened towel and the method further comprises blotting off some of the pigment before the step of pressing the unique part of a user's anatomy with the pigment onto the location adapted to accept an impression of the unique part of a user's anatomy within the pre-printed design and cleaning off the pigment using the pre-moistened towel after the step of pressing the unique part of a user's anatomy with the pigment.

18. A artistic kit comprising:
an applicator having a pigment, the applicator adapted to apply the pigment to a nipple of a user;
an artistic medium;
a pre-printed design on a front side of the artistic medium; and
a location adapted to accept an impression of the nipple of the user.

19. The artistic kit of claim 16, wherein the pigment is selected from the group consisting of paint and ink.

20. The artistic kit of claim 16, wherein the applicator is pre-loaded with the pigment.

21. The artistic kit of claim 16, wherein the pigment is provided in a container and the applicator is impregnated with the pigment by a user.

22. The artistic kit of claim 16, wherein the applicator is a brush.
